(19) United States
(12) Patent Application Publication
(10) Pub. No.: US 2010/0082459 A1
(43) Pub. Date: Apr. 1, 2010

(54) MEDICAL WASTE MANAGEMENT SYSTEM AND METHOD FOR MAKING AND USING SAME

(75) Inventors: David P. Tusa, Houston, TX (US); Burton J. Kunik, Houston, TX (US)

Correspondence Address: ROBERT W STROZIER, P.L.L.C, PO BOX 429, BELLAIRE, TX, 77402-0429, US

(73) Assignee: SHARPS COMPLIANCE, INC., Houston, TX (US)

(21) Appl. No.: 12/243,932

(22) Filed: Oct. 1, 2008

(51) Int. Cl. G06Q 10/00

(52) U.S. Cl. 705/28; 705/1

(57) ABSTRACT

A comprehensive medical waste management system for establishing and maintaining medical waste preparedness and cradle to grave asset management in the event of non-emergency and emergency situations is disclosed, where the system includes at least: a central control subsystem, a warehousing subsystem, a distribution subsystem, a tracking subsystem, a retrieval subsystem, and a disposal subsystem, and methods for making and using same.

### BACKGROUND OF THE INVENTION

1. Field of the Invention

The present invention relates to a comprehensive medical waste management system for establishing and maintaining medical waste preparedness and cradle-to-grave medical waste asset management in non-emergency and emergency situations requiring medical waste assets and asset management, and methods for making and using same.

More particularly, the present invention relates to a comprehensive medical waste management system for establishing and maintaining medical waste preparedness and cradle-to-grave medical waste asset management in non-emergency and emergency situations, where the system includes at least: a control subsystem, a warehousing subsystem, a distribution subsystem, a tracking subsystem, a retrieval subsystem, and a disposal subsystem. The present invention also relates to methods for making aspects of the system, for implementing the system and for using the system.

2. Description of the Related Art

In the event of health emergencies including natural and man-made disasters, medical personnel, equipment and supplies are generally distributed to the site of the emergency or emergencies. These infrastructures are fairly well designed and conceived; however, little or no consideration has been given to the large amount of medical waste that would be generated in such emergencies.

Thus, there is a considerable need in the art for systems that can handle medical waste and that can be deployed prior to, concurrent with or subsequent to the deployment of the medical personnel, equipment and supplies to non-emergency and emergency sites.

### SUMMARY OF THE INVENTION

The present invention provides a waste management system including at least: a control subsystem, a distribution subsystem, a tracking subsystem, a retrieval subsystem, and a disposal subsystem. The control subsystem includes at least a plurality of local control units, each unit including command and control hardware, software, routines, and protocols and communication hardware, software, routines, and protocols. The control subsystem may also include a command and control center for centralized management and control. The distribution subsystem includes at least: (1) a plurality of warehouse facilities having inventory control and management equipment, routines and protocols, and (2) asset distribution equipment, routines and protocols. Each warehousing facility including at least: (a) a local command and control unit, (b) deployable medical waste management system kits or units, and (c) sufficient inventory to prepare a desired number of deployable kits and to update deployable kits. Each warehousing facility can also include: (d) a kit preparation area, (e) an inventor storage area, (f) a kit storage area, and (g) a kit deployment or distribution area. The tracking subsystem includes hardware and software for tracking kits in the warehouse facilities and/or kits distributed to emergency or non-emergency sites. The tracking subsystem may also include active and/or passive tag technology to track kits and/or items in each of the kits. The retrieval subsystem includes retrieval equipment, routines and protocols. The retrieval equipment, routines and protocols may be designed and authorized to handle various classifications of medical waste. The disposal subsystem include disposal equipment, routines and protocols for disposing of any type of medical wastes. The disposal subsystem may also be designed and authorized to handle various classifications of medical waste.

The present invention provides a waste management system including at least: a control subsystem, a distribution subsystem, a tracking subsystem, a retrieval subsystem and a disposal subsystem. The control subsystem includes a central control unit and a plurality of local control units. Each control unit includes command and control hardware, software, routines, and protocols and communication hardware, software, routines, and protocols. The distribution subsystem includes at least: (1) a plurality of warehouse facilities having inventory control and management equipment, routines and protocols, and (2) asset distribution equipment, routines and protocols. Each warehousing facility including at least: (a) a local command and control unit, (b) deployable waste management kits, and (c) sufficient inventory to prepare a desired number of deployable kits and to update deployable kits or units. Each warehousing facility can also include: (d) a kit preparation area, (e) an inventor storage area, (f) a kit storage area, and (g) a kit deployment or distribution area. The tracking subsystem includes hardware and software for tracking kits in the warehouse facilities and/or kits distributed to emergency or non-emergency sites. The tracking subsystem may also include active and/or passive tag technology to track kits and/or items in each of the kits. The retrieval subsystem includes retrieval equipment, routines and protocols. The retrieval equipment, routines and protocols may be designed and authorized to handle various classifications of medical waste. The disposal subsystem include disposal equipment, routines and protocols for disposing of any type of medical wastes. The disposal subsystem may also be designed and authorized to handle various classifications of medical waste.

The present invention provides a method for implementing and using medical waste management system comprising the step of providing a control subsystem adapted to manage assets, warehouse assets, distribute asset, and collect and dispose of used assets, locally or collectively. The method also includes the step of warehousing medical waste management assets in one warehouse facility or a plurality of warehouse facilities. The warehousing step includes the steps of preparing deployable medical waste kits, storing deployable medical waste kits, and maintaining deployable medical waste kits. In the event of a non-emergency or emergency situation or a plurality of non-emergency or emergency situations, the method also includes the step of distributing deployable medical waste kits via deployment transportation assets to one or more sites associated with the non-emergency or emergency local or non-emergency or emergency locals based on a deployment order or request, which specifies the number of kits needed, the location for delivery, and the type of kits needed. The distributing step is adapted to distribute an effective number of warehoused deployable medical waste kits from one or more of the warehouse facilities to one site or a plurality of sites at each emergency or non-emergency local, where the number of deployable medical waste kits is sufficient to collect and temporarily store an amount of generated medical waste based the order or request and any subsequent orders. The methods also includes the step of retrieving the on-site medical waste via retrieval transportation assets and transporting the on-site medical waste to one or a plurality of disposal facilities. In certain embodiment, the retrieval transportation assets include the United States Postal Service or other non-governmental courier services such as FedEx, DHL, UPS, Lone Star, etc. In other embodiments, the retrieval transportation assets can include appropriate hazardous waste material transportation assets. The method also includes the step of disposing of the retrieved medical waste in one or more of the disposal facilities, where the disposal facilities are adapted to depose of all retrieved medical waste. In certain embodiments, the medical wastes may be sent to different disposal facilities depending on the type of medical waste involved. For example, for normal medical waste, the retrieved medical waste can be sent to any disposal facility. However, if the medical waste include potential contamination for bio-hazards or radio-hazards, the such medical waste will be sent to special disposal facilities adapted and authorized for disposal of hazardous medical waste. The method also includes tracking all deployed medical waste kits. The tracking step may also include tracking all items within each deployable kit. In certain embodiments, the tracking step is performed by a local tracking subsystem associated with local command and control unit. In other embodiments, the tracking step is performed by a central tracking component associate with the central command and control subsystem and a plurality of facility or local tracking components associated with the local command and control unit. In certain embodiment, the tracking subsystem includes the ability to track each deployed kit via global position technology. In other embodiments, the tracking system includes the ability to track each deployed kit via global position technology and active or passive tags on each item in each kit so that the location of each item and each kit can be tracked for retrieval and disposal. Such item tracking may be especially critical in deployments involving hazardous medical waste such as medical waste involving toxins, pathogens (e.g., bacterial, viral, fungal, etc.), radiation, or the like or mixtures or combinations thereof.

The present invention provides a method for implementing and using a medical waste management system of this invention comprising the step of providing a control subsystem including a central control unit and a plurality of local control units. The central control unit is adapted to control the management of all assets, management of the warehousing of all medical waste management system (MWMS) assets, management of the distribution of all MWMS assets, management of the retrieval of all used MWMS assets, management of disposal of all retrieved MWMS assets, and optionally management of the tracking of all MWMS assets. The local control units are adapted to manage local MWMS assets, manage warehousing of local MWMS assets, manage distribution of local MWMS assets, manage local retrieval of used MWMS assets, manage local disposal of retrieved MWMS assets and optionally manage local tracking MWMS assets. The method also includes the step of warehousing medical waste management assets in one warehouse facility or a plurality of warehouse facilities. The warehousing step includes the steps of preparing deployable medical waste kits, storing deployable medical waste kits, and maintaining deployable medical waste kits. In the event of a non-emergency or emergency situation or a plurality of non-emergency or emergency situations, the method also includes the step of distributing deployable medical waste kits via deployment transportation assets to one or more sites associated with a non-emergency or emergency local or non-emergency or emergency locals based on a deployment order or request. The distributing step is adapted to distribute an effective number of warehoused deployable medical waste kits from one or more of the warehouse facilities to one site or a plurality of sites at each emergency or non-emergency local, where the number of deployable medical waste kits is sufficient to collect and temporarily store an amount of generated medical waste based the order or request and any subsequent orders. The methods also includes the step of retrieving the collected and stored on-site medical waste via retrieval transportation assets and transporting the collected medical waste to one or more disposal facilities, where the medical waste is properly treated under controlled conditions. In certain embodiments, the retrieval transportation assets include the United States Postal Service or other non-governmental couriers services such as FedEx, DHL, UPS, Lone Star, etc. In other embodiments, the retrieval transportation assets can include appropriate hazardous waste transportation assets. The method also includes the step of disposing of the collected medical waste in one disposal facility or a plurality of disposal facilities, where each disposal facility is adapted to depose of all medical waste retrieved from each emergency or non-emergency local. The method also includes tracking all deployed medical waste kits. The tracking step can include tracking all items within each deployable kit. In certain embodiments, the tracking step is performed by a local tracking subsystem. In other embodiments, the tracking step is performed by a central tracking component and a plurality of facility tracking components. In certain embodiment, the tracking subsystem includes the ability to track each deployed kit via global position technology. In other embodiments, the tracking system includes the ability to track each deployed kit via global position technology and active or passive tags on each item in each kit so that the location of each item and each kit can be tracked for retrieval and disposal.

### BRIEF DESCRIPTION OF THE DRAWINGS

The invention can be better understood with reference to the following detailed description together with the appended illustrative drawings in which like elements are numbered the same:

FIG. 1A depicts an embodiment of a waste management system of this invention.

FIG. 1B depicts an embodiment of a warehousing facility of this invention.

FIG. 2A depicts an embodiment of a waste management deployable kit of this invention.

FIG. 2B depicts another embodiment of a waste management deployable kit of this invention.

FIG. 3 depicts another embodiment of a waste management deployable kit of this invention.

FIG. 4A depicts another embodiment of a waste management deployable kit of this invention.

FIG. 4B depicts another embodiment of a waste management deployable kit of this invention.

FIG. 5 depicts another embodiment of a waste management deployable kit of this invention.

FIG. 6 depicts a conceptual flow chart of the operations of the system.

FIG. 7 depicts another conceptual flow chart of the operations of the system.

### DETAILED DESCRIPTION OF THE INVENTION

The inventors have found that a medical waste management system and method is needed to store, distribute, manage, retrieve and depose of medical waste in the emergency and non-emergency situations, where the system is designed to supply a location with one or a plurality of medical waste kits, where each kits includes a plurality of medical waste container items, an optional medical waste kit management unit, and optionally other medical items. The inventors have designed the system and method to: 1) prepare and stock pile, warehouse or store medical waste handling kits; 2) manage asset inventory and medical waste handling kits; 3) distribute manage medical waste kits to emergency or non-emergency locations; 4) retrieve used medical waste containers; and 5) disposal of medical waste. The system can optionally be designed to 6) update kits, and 7) track kits or kits and items.

### Introduction

Currently, local, state and national organizations exist for managing, handling and distributing medical assets and teams to one or more locations in the event of one or more non-emergency or emergency situations such as man made and natural disasters. Such emergency response systems are well designed, but suffer from one major deficiency. These systems generally do not include any system or method for effective and efficient management of medical waste. Such a system and method would be of significant importance in all non-emergency and emergency situation, especially in the event of a biological outbreak, where medical waste must be properly and effectively managed and contained to decrease the potential spread of a biological agent. However, even in general emergency situations, sharps, needles, catheters, or other used medical devices need to be handled with care to prevent inadvertent spread of certain blood borne incurable or difficult to cure disease such as HIV, HIV AIDS, hepatitis A, B and C, or the like.

The present invention is designed to address this deficiency by providing a comprehensive medical waste management system and method for use in emergency and non-emergency situations. The system is designed to create a medical waste management infrastructure to support first and subsequent emergency responders improving waste management deployment, collection, retrieval and disposal.

The system provides specific capabilities for supporting public health and medical preparedness including at least: 1) management of medical waste assets, 2) preparation of medical waste management kits, 3) warehousing medical waste kits, 4) updating medical waste kits, 5) distributing medical waste kits, 6) retrieving disposable kit items, 7) disposing of disposable kit items, and 8) optionally tracking kits or kits and kit items. The system can also include: 1) operation management training, 2) asset distribution training, 3) emergency response training, 4) asset retrieval training, and 5) asset disposal training. The system can also include: 1) countermeasure stockpiling and distribution, 2) mass casualty care and 3) community resilience. The system is designed to support medical waste collection, retrieval and disposal as well, where the medical waste retrieval and disposal can be on an unit or container basis.

The system provides medical waste management assets, medical waste asset management, medical waste asset warehousing, on-site program management, subject matter expertise, consultation, and technical support.

### General Performance Objectives

### Operations

The components of the system of this invention include at least the following: (a) distributable medical waste management kit or unit preparation, warehousing, updating, and distributing, (b) optionally, distributable medical waste management kit or unit tracking, retrieving and disposing, (c) communications, (d) command and control, (e) staffing and staff management, (f) optionally, staff training, distribution training, simulation response training, and coordinated simulation training, (g) optionally, record management, and (h) optionally, report creation, distribution and management.

### Medical Waste Management System Assets and Technology and Infrastructure

The systems of this invention include components, definitions, research, analyses, prototypes and deployed Medical Waste Management System assets and an infrastructure to provide a baseline of technical capabilities supporting efficient information exchange and storage, situational awareness and action processing on both a daily and emergency response basis by ensuring the availability of decision support tools (e.g., databases, reference library, pre-scripted message templates, etc.), multi-media visual displays, and the ability to communicate down to designated authorities. These components entail redundant communication capabilities up to the classified level (and IT access security through approved security solutions) and requires an end-to-end IT systems approach.

### Facilities Planning

The system includes a component to assist response teams with the design, development, and implementation of managed medical waste inventory assets and facilities required to meet the needs of supporting public health and medical preparedness pertaining to the Medical Waste Management System of this invention.

This component will assist the science teams in leveraging the lessons learned from current or past operations to produce operational documentation (e.g., concepts, plans, processes, information flows, interagency agreements, and other documentation delivered as technical reports) so that an emergency management organization is properly prepared to meet future public health emergencies.

### Contract/Task Management

The system will provide two standard deliverables: (a) Technical Reports for operational documentation, planning, analyses, prototype performance, etc. and (b) Monthly Report for management of the task order effort. The system is designed to generate and deliver Technical Reports as required or desired.

The system will provide status, messaging, resource identification, credential management, people and asset tracking and logistical resource management. The exact format and information provide in this component will depend on requirements identified by the agency implementing the system of this invention such as the requirements established.

The system will maintain a communication component that encompasses full online assets visibility of the readiness level of the Medical Waste Management System assets. This system will include a database of individuals that have received and are certified in the understanding of the Medical Waste Management System, messaging, logistical deployment demands, hours of service and door to door accountability.

The system will also include an intranet based portal and/or internet based portal such as a WEB-based portal, to support client access to system resources, system training certificates, system kit inventory, and other system informational that may be required by the agency implementing the Medical Waste Management System of this invention.

### Managed Inventory Warehousing

The warehousing component or subsystem of this invention includes at least: (a) facilities management, (b) situation awareness for distribution of assets, (c) inventory management, (d) maintaining inventory/asset integrity, (e) inventory/asset and facility security, (f) facility safety, (g) record and documentation management, (h) reporting, (i) quality assurance/quality control, (j) optionally database creation, updating and maintenance; and (k) inventory and asset tracking.

For the purposed of this invention, the term warehousing means the receipt and storage of supplies, equipment, ancillary support items, and the preparation of various item into kits for distribution if and when required to respond to a public health non-emergency and/or emergency manmade and/or natural situation and/or disasters. The warehousing subsystem includes providing necessary facilities, expertise, labor, and materials to accept delivery, unload, store, and account for all inventory acquired by an agency implementing the Medical Waste Management System of this invention. All acquired and/or prepared products will be controlled, protected, managed and optionally tracked in a manner that will prevent damage and/or loss while being the assets are being warehoused. The warehouse facilities will include an environmental control subsystem to maintain the Medical Waste Management System assets in a desired condition. The environmental control subsystem is designed to control temperature, pressure, humidity, or other controllable physical attributes of the warehousing facility. The warehousing facilities will also generally include office space, staging areas, kit preparation areas, and outside/parking for staff and tractor-trailers or other supply and deployment assets.

### Facilities Design, Monitoring and Maintenance

The system also includes a component to maintain written procedures to describe the operation, maintenance (including scheduled storage temperature alarm testing, other component testing, etc.), and Out-Of-Specification reporting (including emergency contact information with back-up personnel) of all environment-controlled areas such as temperature-controlled storage areas or the like.

The warehousing subsystem will also provide warehouse facilities of suitable size and construction to facilitate proper warehousing, kit preparation, cleaning, maintenance, and operations.

The warehousing subsystem will also include a document maintenance subcomponent designed to maintain a written maintenance program history and to keep documentation ensuring that all warehousing or storage facilities are maintained in a good state of repair and cleanliness. They warehouses or storage facilities will institute appropriate measures concerning cleaning, environment control, refrigeration, maintenance, pest control, and the quality system governing these procedures to ensure that the storage specifications for stored assets meet a given standard such as the current Good Manufacturing Practices (cGMP) standards.

### Comprehensive Qualification Program

All environment-controlled or climate-controlled storage areas and climate monitoring systems will operate according to documented pre-specified testing procedures and endpoints relevant to the qualifications. The system with also provide results documentation in a qualifications report and documentation storage in appropriate electronic and/or physical formats.

### Receipt and Storage of Products

The warehousing subsystem also includes a component for maintaining physical control and ongoing accounting of products received, stored, kitted, withdrawn, and delivered. For each withdrawal or delivery, the warehousing subsystem will include tracking and inventory information, where the information will include at least lot number and inventor data, date data, and quantity control data. This information will be stored in appropriate databases for kit tracking and inventory management and each withdrawal or delivery will include a shipment manifest (paper or electronic or both) that is reconciled with a pack list and with the corresponding data stored in the database or databases.

The tracking component will include inventory routines so that 100% of inventory is accounted on an intermittent, periodic or continuous basis. In certain embodiments, the periodic basis daily. In other embodiments, the periodic basis is weekly. In other embodiments, the periodic basis is bi-weekly. In other embodiments, the periodic basis is monthly. In other embodiments, the periodic basis in quarterly. In other embodiments, the periodic basis is semi-annually. In other embodiments, the periodic basis annually.

### Quality Control

The warehousing subsystem will provide mechanisms to ensure that all products will be received, handled, stored, and shipped in accord with manufacturer requirements as well as applicable federal, state or local rules or regulations governing the storage, handling and distribution of the Medical Waste Management System assets.

The warehousing subsystem will including a comprehensive quality subsystem complying in all material respects with the regulations contained in 21 CFR Parts 210 and 211 applicable to holding finished pharmaceuticals and goods, Title 21 CFR Part 820 applicable to quality system regulation, Title 21 CFR Part 600 applicable to Biological Products, 21 CFR Part 11 regulations applicable to Good Manufacturing Practices (GMPs), current edition of the USP applicable to holding of pharmaceuticals, and FDA and current Good Manufacturing Practices (cGMP) standards for environmental and quality controls as well as any local or state regulations imposing additional compliance requirements.

The warehousing subsystem will also be implements with an appropriate calibration, and maintenance/repair program for all environment or climate control equipment or climate monitoring systems established and documented within their quality system. Appropriate schedules for all calibration, maintenance, and regular replacement of such climate control equipment and system as well as the responsibilities for the execution of the schedules will be clearly defined within the system. All calibration, maintenance/repair data stored and maintained in individual equipment files in an accessible database.

Each warehouse or storage facility utilizes a master warehouse layout plan that aids in locating inventories by rack, shelf, and section. Each facility is designed to maintain all facility standard operating procedures (FSOPs). Facility administrative personnel are responsible for employees training on all approved FSOPs applicable to their assigned and for maintaining the FSOPs in an employee accessible manner—electronic copies and/or hard copies. Facility administrative personnel are also responsible for preparing written deviations and/or non-conformance reports documenting deviations from FSOPs and FSOP protocols, for investigating such deviations, and for performing corrective actions/preventive actions (CAPA) to correct the causes of the deviation and for implementing corrective procedures and follow-up procedures, if necessary.

Each facility management team is designed to contact the central control team within a specified period of time such as immediately, within one hour, within one business day, etc., for guidance on handling inventoried items that have been affected by temperature or humidity deviations, and notify the central control team in writing of any product losses, including loss due to spoilage, theft, fire, water damage, etc., within a specified period of time such as immediately via electronic transmission, within one hour by electronic transmission, within one business day by electronic transmission or overnight courier, etc.

### Safety

Each warehouse facility also includes acceptable safety monitoring, where monitoring can be reviewed on an annual basis for compliance with governmental policies such as OSHA safety policies, etc.

### Security

Each warehouse or storage facility also includes a 24-hour security monitoring and response subsystem. The subsystem is adapted to monitor and limit access to facility assets. Operating inventories are controlled by authorized personnel and entry into the facility is on an as need basis. The subsystem can also include personnel tracking so that unauthorized entrance can be immediately detected and security protocols implements. The subsystem tracks all entrances into the facilities storing individual codes of entrants, date of entry, time of entry, date of exit, time of exit, etc. The subsystem can also include facility monitoring kits or units adapted to record and store audio, visual, audio visual, or similar data on a continuous, intermittent, or periodic basis. The system can also be designed to record only when an activating event occurs such as a change in a detected variable such as motion, temperature, pressure, humidity, sound, visual attributes, unauthorized entry, or the like.

### Fire Protection

The facility monitoring subsystem can also include fire monitoring, facility integrity monitoring, toxin monitoring such as CO, or other types of facility monitoring adapted to improve facility security and facility integrity and stored inventory integrity. Each facility can include areas for different environments such as cold rooms, clean rooms, low humidity rooms, high humidity rooms, etc.

### Electronic Environment or Climate Monitoring

The monitoring subsystems is adapted to include state-of-the-art technologies in environment, climate, temperature and/or humidity monitoring throughout the warehouse facilities. The subsystem is adapted for real-time, 24-hour monitoring with alarm states when temperature, humidity and/or other monitored variables vary from preset ranges.

### Redundant Systems

Each warehouse facility can also include a backup electric power generator or generators for automatically transferring or switching between utility supplied power and generator supplied power to ensure a safe, continuous and reliable source of power in the event of failure of electric power supply from the utility companies. Generally, each facility can also include at least: (a) a back-up generator to power key facility components, including all climate control equipment, all monitoring subsystems, all communication systems, all computer systems, or other key facility components, (b) uninterrupted power supplies (UPS) for all climate control equipment, all monitoring subsystems, all communication systems, all computer systems, or other key facility components, (c) data back-up subsystems for all climate control equipment, all monitoring subsystems, all communication systems, all computer systems, or other key facility components, and (d) UPSs for all computers, data storage devices, data transmission devices, data receiving devices, or other hardware component required for data collection, storage, manipulation, transmission, or the like and hardware components controlling hardware and software communication, internal and external.

### Inventory Management

Each warehouse facility also includes software routines for tracking inventory in the facilities and routines for physical inventory balancing and discrepancy handling. The routines are adapted to track at least supplies, equipment, ancillary supplies, and other items that will be maintained in the facility for responding to non-emergency and emergency situations. The routines include logging and scheduling preventive maintenance, validations, and calibrations of equipment requiring such activities.

### Preparing Shipments

Each facility also includes kits, labels, tags or otherwise prepared products for shipment, deployment or distribution upon request by a designated response team.

Each facility will be responsible for assembling orders and delivering the orders to one or more specified destinations.

### Data Management, Document Control, and Reporting

Each facility also includes record handling routines and protocols for complying with the response team approved quality assurance standards, including formal document control programs to manage the approval, distribution, archival, and change control of all cGMP relevant documents, such as standard operating procedures (SOPs), validation documents, and training records.

Each facility also includes routines and protocols for generating and presenting all required documentation, receipts, and reports on demand to designated response team in an acceptable format.

### Product Insurance

Each facility will maintain custodial risk insurance or other similar insurance in an adequate amount to cover the commercial replacement value of all supplies, equipment, ancillary support items, and other materials and items held in the facility for the waste management control system of this invention.

### Training and Exercising

The Medical Waste Management System of this invention also includes training and exercise components adapted to designated officials in the planning and management of an effective response to man made disasters such as terrorist attacks, natural disasters, or industrial and technological accidents. The training and exercise components are especially adapted to focus on the design of a comprehensive system for responding to, staging and distributing assets, tracking assets and asset management so that the system can quickly deploy assets to individual sites for proper medical waste management at disasters or accident sites improving public health and safety during and after an disaster or accident. The system design includes issues for quickly determining an incident location and determining a number of response sites and determining a number of waste management kits or units to be deployed to each response site. The number of sites and the number of kits or units deployed to each site need to be managed and optimized to enhance waste collection, binning, container placement, etc. for responding to different scale incidents. Site design includes issues for site management, site staffing, site material and equipment support, and site process flow that directly affect the number of people each site is able to process.

### Robust and Recurring Training and Exercising

The Medical Waste Management System of this invention also includes optimization components to assist the response team with establishing a robust and recurring training and exercise program for responding to disasters in an effective and efficient manner. This component is an inherent part of developing an operational concept and is a key feature for response optimization. This component may include overall training and exercise plans, lesson outlines, on-line or computer based training modules, tradeoff analyses, and inputs to a variety of documents delivered as technical reports. The training developed by the components will need to be certified through the appropriate organizations to be a Continuous Education (CE) certified program. Certificates of completion will be maintained and produced by the system.

The Medical Waste Management System of this invention is also adapted to be a nationwide preparedness training and education program for state and local health care providers, first responders, and governments. This training will include an explanation of the Medical Waste Management System and to enhance overall mission and mission operations.

### Medical Waste Management System Assets

The Medical Waste Management system of this invention also includes a clear and concise list of materials required to formulate deployable medical material waste kits or units as well as the medical waste disposal kits or units for use in the system, supplies for preparing and updating the deployable medical material waste kits or units, equipment for preparing and deploying the deployable medical material waste kits or units, and other items for preparing, updating and deploying the deployable medical material waste kits or units.

Each warehousing facility includes at least the following items: (a) a quantity of medical waste disposal container, generally including a collection of different sized containers, (b) a quantity of non-containerized waste disposal items such as trash bags or the like, and (c) auxiliary items.

In certain embodiments, each container includes: (i) United States Post Office (USPS) approved for transporting small quantities of medical waste, (ii) polyethylene puncture and leak resistant container, (iii) a protective 4 mil bag liner, (iv) instructions in both English and other appropriate languages (e.g., Spanish), (v) bar-coded manifest and online tracking and proof of destruction, (vi) Food and Drug Administration (FDA) 510(k) approved medical device, (vii) independently tested for compliance with standards for medical waste transportation through the USPS, (viii) all appropriate USPS permits, (ix) opening of container at 45 degree angle and sturdy handle to facilitate ease of use, (x) listed as an Environmental Protection Agency-approved solution for proper disposal of medical waste and (xi) permitted and packaged for pre-arranged return transportation including postage.

In other embodiments, some of the containers are designed to contain toxins, bio-active agents, lethal agents, radiological agents, or other highly hazardous agents. Such containers are designed and constructed to meet all necessary governmental laws, rules or regulations governing the design, construction and transportation of such containers.

In certain embodiments, each warehousing facility includes: (a) two gallon medical waste disposal subunits; (b) three gallon medical waste disposal subunits; (c) five gallon medical waste disposal subunits; (d) signage kits; (e) corrugated trash receptacles; (f) trash bags; (g) twist ties; (h) chemical resistant nitrile gloves; (i) protective clothing coveralls; (j) Econo-wrapper; (k) industrial tape; (l) industrial markers; (m) tape dispensers; (n) safety glasses; and/or (o) other items that may be needed or required.

In certain embodiments, each two gallon medical waste disposal subunit includes: (i) United States Post Office (USPS) approved for transporting small quantities of medical waste, (ii) polyethylene puncture and leak resistant container, (iii) a protective 4 mil bag liner, (iv) instructions in both English and other appropriate languages (e.g., Spanish), (v) bar-coded manifest and online tracking and proof of destruction, (vi) Food and Drug Administration (FDA) 510(k) approved medical device, (vii) independently tested for compliance with standards for medical waste transportation through the USPS, (viii) all appropriate USPS permits, (ix) opening of container at 45 degree angle and sturdy handle to facilitate ease of use, (x) listed as an Environmental Protection Agency-approved solution for proper disposal of medical waste and (xi) permitted and packaged for pre-arranged return transportation including postage.

In certain embodiments, each three gallon medical waste disposal subunits includes: (i) United States Post Office (USPS) approved for transporting small quantities of medical waste, (ii) include polyethylene puncture and leak resistant container, (iii) a protective 4 mil bag liner, (iv) instructions in both English and Spanish, (v) bar-coded manifest and online tracking and proof of destruction, (vi) Food and Drug Administration (FDA) 510(k) approved medical device, (vii) independently tested for compliance with standards for medical waste transportation through the USPS, (viii) all appropriate USPS permits, (ix) opening of container at 45 degree angle and sturdy handle to facilitate ease of use, (x) listed as an Environmental Protection Agency-approved solution for proper disposal of medical waste and (xi) permitted and packaged for pre-arranged return transportation including postage.

The contractor shall provide five gallon mail-back medical waste disposal systems as follows, (i) United States Post Office (USPS) approved for transporting small quantities of “soft” medical waste (clinician-defined), (ii) include polyethylene puncture and leak resistant container, (iii) a protective 4 mil bag liner, (iv) instructions in both English and Spanish, (v) bar-coded manifest and online tracking and proof of destruction, (vi) Food and Drug Administration (FDA) 510(k) approved, (vii) independently tested for compliance with standards for medical waste transportation through the USPS, (viii) all appropriate USPS permits, (ix) bucket style with large opening to facilitate ease of use, (x) listed as an Environmental Protection Agency-approved solution for proper disposal of medical waste and (xi) permitted and packaged for pre-arranged return transportation including postage.

Each facility can also include a variety of ancillary items adapted to support medical waste collection and deposition into a medical waste disposal container. Each facility also includes sufficient kit signage, where the sufficient means at least a ten percent excess of signage over kits. The kit signage are of a type, name and size approved for use in with an given agency, governmental or private. The signage kits will also include barricade tape and other support items to help with the setup of each Medical Waste Management site.

Each facility also includes: (1) corrugated trash receptacles, (2) trash bags, (3) twist ties, (4) chemical resistant nitrile gloves, (5) protective clothing, (6) Econo-wrapper, (7) industrial tape, (8) industrial markers, (9) tape dispensers, (10) safety glasses, and/or (11) other desired or needed items.

In certain embodiments, each facility also includes: (1) corrugated trash receptacles, (2) trash bags, (3) multicolored twist ties, (4) chemical resistant nitrile gloves, (5) protective coveralls and other type of protective clothing, (6) Econo-wrapper, (7) industrial tape, (8) multicolored plastic tags pre-wired, (9) industrial markers, (10) tape dispensers, (11) safety glasses and/or (12) other items that be required or desired.

The contractor shall assemble, kit, label, and store ready to deploy 2500 person Medical Waste Management System Kits. In certain embodiments, the kits are palletized on standard wooden pallets with a dimension not greater than 48 inches by 48 inches. The pallets are have a height not greater than 50 inches. The pallets are shrink-rapped with transparent pallet wrapping. In one embodiment, each 2500 person kit comprises two gallon mail-back medical waste disposal systems, three gallon mail-back medical waste disposal systems, five gallon mail-back medical waste disposal systems, one signage kit or packet, corrugated trash receptacles, trash bags, multicolored twist ties, chemical resistant nitrile gloves, protective overalls or other types of protective clothing, Econo-wrapper, industrial tape, multi-colored plastic tags pre-wired, industrial markers, safety glasses and/or other items that may be required or desired. In certain embodiment, the number of palletized kits does not exceed 20% of the total amount of Medical Waste Management System assets in the facility.

Each facility that also includes a medical waste disposal system are adapted to comply with all federal, state and local state-approved and permitted treatment facility with destruction capabilities including incineration to support the destruction of the Medical Waste Management System assets. This facility must be operation during non-deployment times to handle assets used for Public Health non-emergency deployments.

The contractor will be required to perform a rotation in place handling of the Medical Waste Management System assets to insure that the designated authorities are receiving clean and up to date products.

The system of this invention also includes pre-packaged transportable kits or units. Each unit includes sufficient supplies of a variety of waste disposal containers and other materials to store a given amount of medical waste. The size of the units and the items included in the units is dependent on the number of person the unit is intended to service, the nature of the emergencies, the nature of the collection and disposal protocols to be used and on the number of units being deployed to a site.

### DETAILED DESCRIPTION OF THE DRAWINGS

### Facilities and Kits

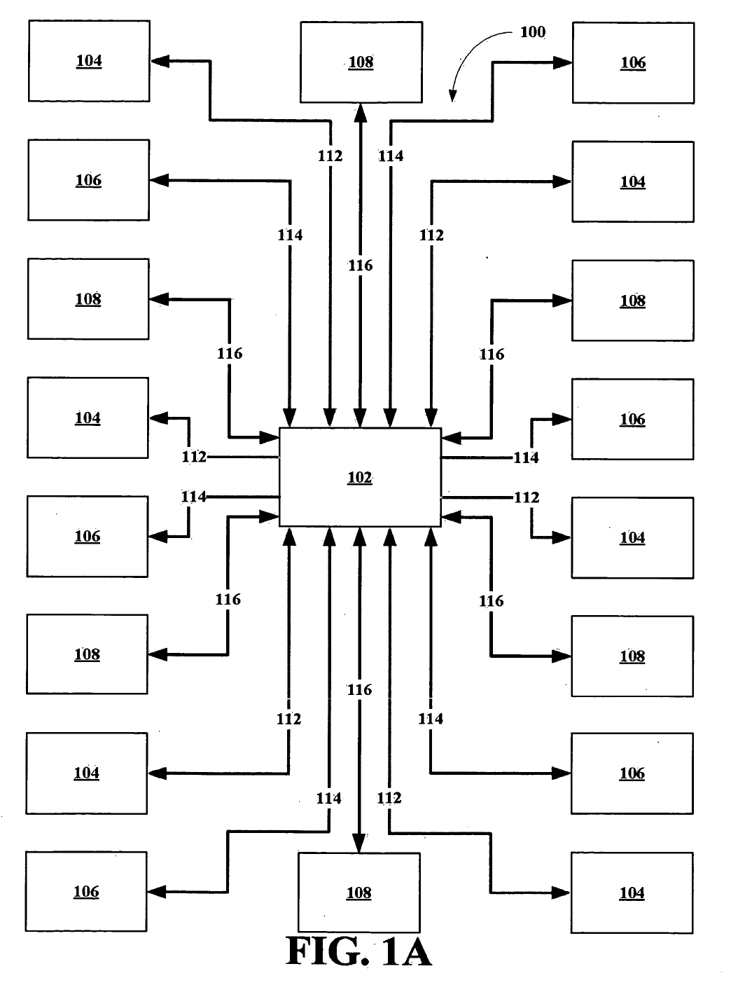

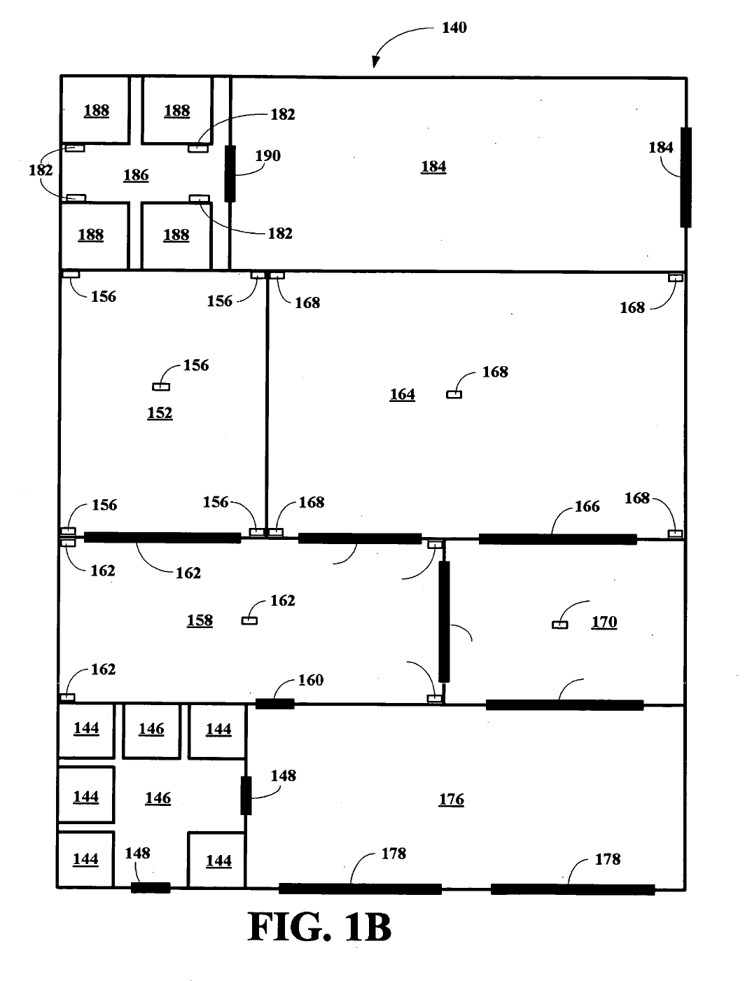

Referring now to FIG. 1A, an embodiment of a waste management system of this invention, generally 100, is shown to include a central command and control facility 102, a plurality of warehouse facilities 104, one retrieval facility 106 or a plurality of retrieval facilities 106, and one disposal facility 108 or a plurality of disposal facilities 108. Each warehouse facility 104 is in data communication via data communication links 110 with the central facility 102. The data communication links 106 support a robust wire and/or wireless communications protocols such as intranets, internets or other broadband global networks, phone lines, or the like. Each warehouse facility 104 is in data communication via data communication links 112 with the central facility 102. The data communication links 112 support a robust wire and/or wireless communications protocols such as intranets, internets or other broadband global networks, phone lines, or the like. Each warehouse facility 104 is in data communication via data communication links 114 with the central facility 106. The data communication links 112 support a robust wire and/or wireless communications protocols such as intranets, internets or other broadband global networks, phone lines, or the like. Each warehouse facility 104 is in data communication via data communication links 116 with the central facility 108. The data communication links 112 support a robust wire and/or wireless communications protocols such as intranets, internets or other broadband global networks, phone lines, or the like. Although the three facilities 104, 106, and 108 are shown here as different, the three operations described for each of the three facilities 104, 106, and 108, can be combined so that each facility has a warehousing component, a retrieval component and a disposal component as shown in FIG. 1B.

Looking at FIG. 1B, for facilities that includes all three components, the facility layout can be as illustrated in this illustrative embodiment, generally, 140. Although a specific layout is shown here, the actual layout is not material and will depend on many different things including the aesthetic taste of the management team for each facility; yet the facilities can all be standardized to a single blue print. The facility 140 includes a office component 142. The office component 142 includes offices 144, a computer component 146 and entrances and exits 148. The facility 140 also includes a warehousing component 150, which includes an item storage component 152 having an entrance/exit 154 and environmental sensors 156, a kit preparation component 158 having entrances and exits 160 and environmental sensors 162, a kit storage component 164 having entrance/exit 166 and environmental sensors 168, and a kit staging component 170 having entrance/exit 172 and an environmental sensor 174. The facility 140 also includes a kit deployment component 176 having entrances and exits 178, where kits from the staging component 168 are transferred to transportation assets (not shown) via exit 180. The facility 140 also includes a retrieval component 182 having entrance/exit 184 adapted to receive medical waste assets filled with medical waste slated for disposal. The facility 150 also includes a disposal component 186 including four disposal furnaces 188 and entrance/exit 190. Each furnace 188 includes a control panel 192.

The computer component 146 includes one or a plurality of computers including at least one processing unit, at least one memory unit, at least one mass storage unit, communication hardware and software, inventory management and tracking hardware and software, asset management and tracking hardware and software, deployable kit management and tracking hardware and software, deployed kit management and tracking hardware and software, and sensor monitoring and management hardware and software. The computers can be any computer manufactured for unit in business applications including IBM, Intel, Apple, HP, AMD, Toshiba, Dell, or any other computers.

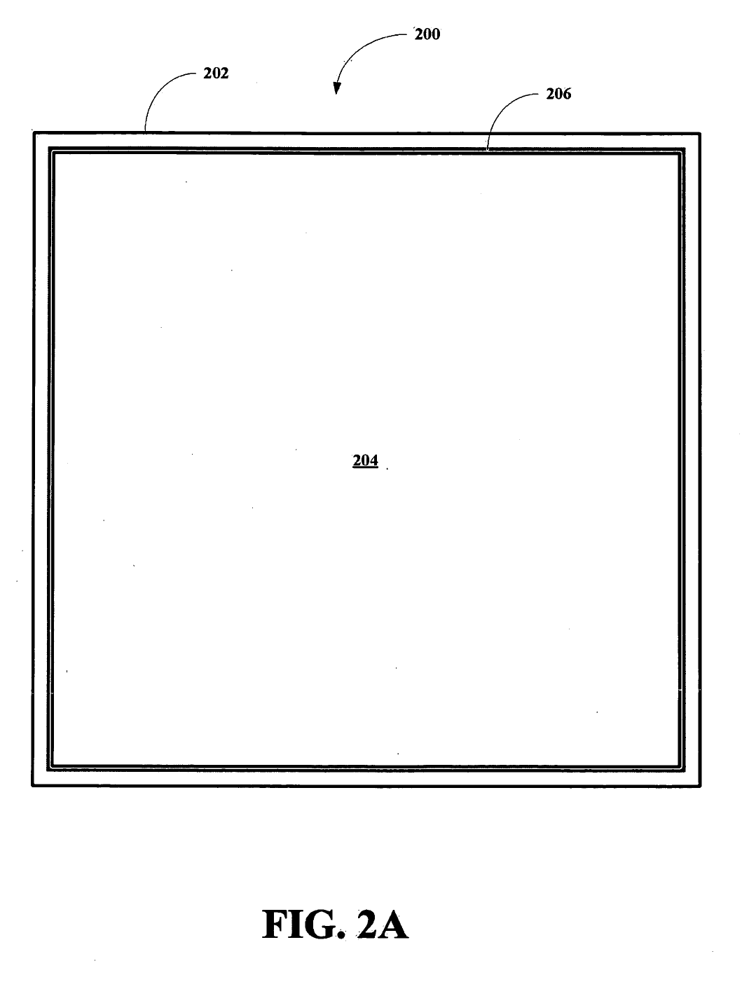

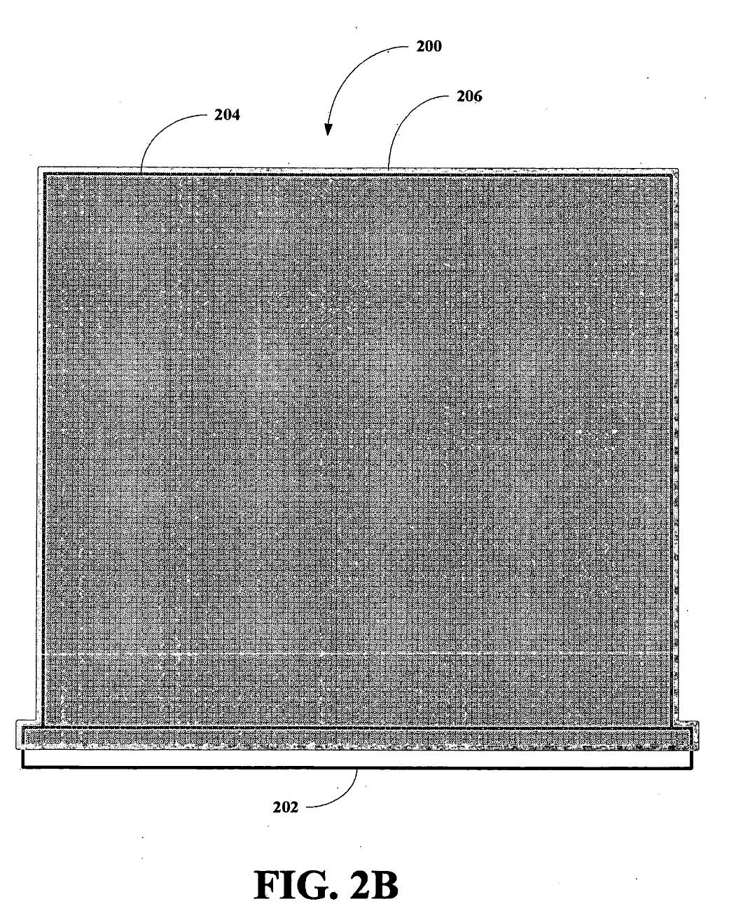

Referring now to FIGS. 2A&B, an embodiment of a waste management deployable kit of this invention, generally 200, is shown to include a pallet 202 on which a grouping of items 204 is placed and surrounded by a shrink wrap plastic covering 206. Of course, the exact dimensions of the pallet 202 and the number and makeup of the items will depend on the type of unit being prepared, how many people it is intended to handle.

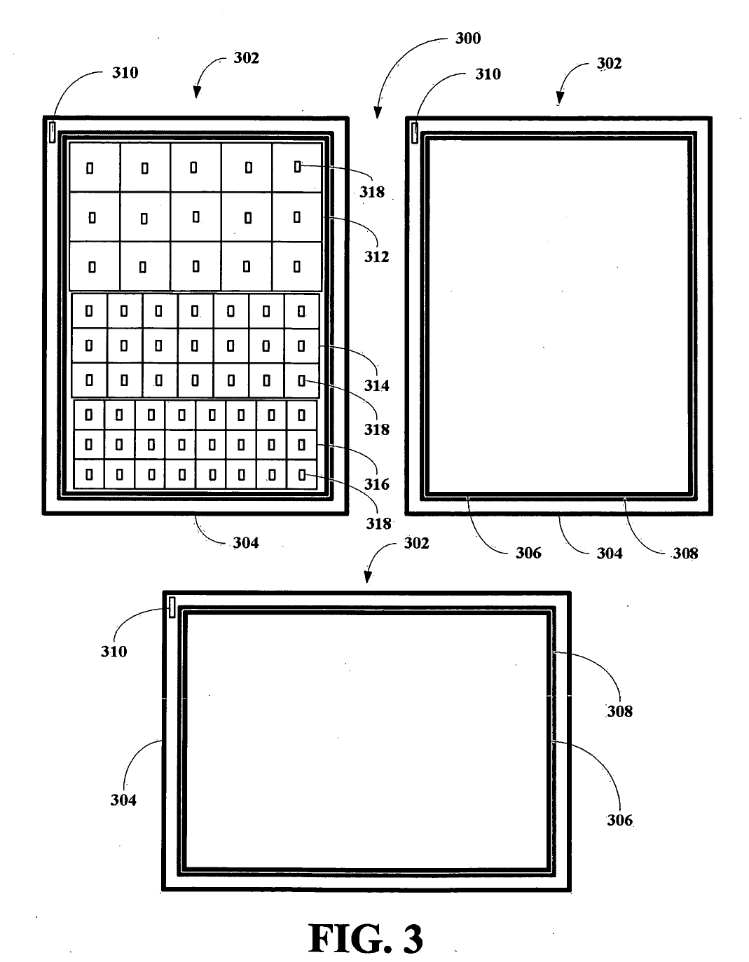

Referring now to FIG. 3, another embodiment of a waste management deployable kit or unit of this invention, generally 300, is shown to include three subunits 302. Each subunit 302 comprises a pallet 304 on which a grouping of items 306 and surrounded by a shrink wrap plastic covering 308. Each pallet 304 can optionally include a tag 310, which can be active or passive and include a GPS component so that the location of each pallet 304 can be monitored on a continuous, periodic or intermittent basis. The grouping of items 306 in one of the subunits 302 can include 5 gal containers 312, 3 gal containers 314, and 2 gal containers 316. Each item 312, 314 and 316 can also include a tag 318, active or passive for tracking the items, and the tags 318 can include a GPS component for continuous, periodic or intermittent tracking of subunit items. Of course, the exact dimensions of the pallet 304 and the number and makeup of the items will depend on the type of unit being prepared, how many people it is intended to handle. Additionally, a single kit may include more or less than three subunits 302 and each pallet 304 can include a different assortment of items including some or all of those disclosed above.

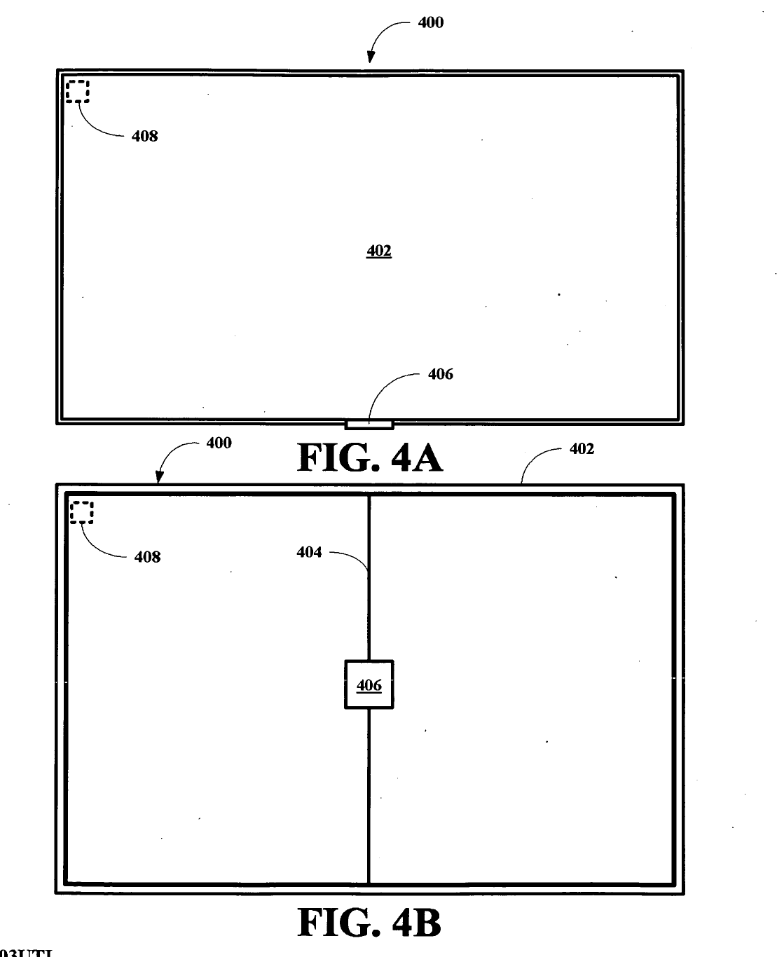

Referring now to FIGS. 4A&B, another embodiment of a waste management deployable kit or unit of this invention, generally 400, is shown to include a sealable container 402 including an openable door 404 and an opening/closing/locking mechanism 406. The container 402 can include a tag 408, active or passive for tracking the items, and the tag 408 can include a GPS component for continuous, periodic or intermittent tracking of containers 402. Of course, the exact dimensions of the container 402 and the number and makeup of the items will depend on the type of unit being prepared, how many people it is intended to handle.

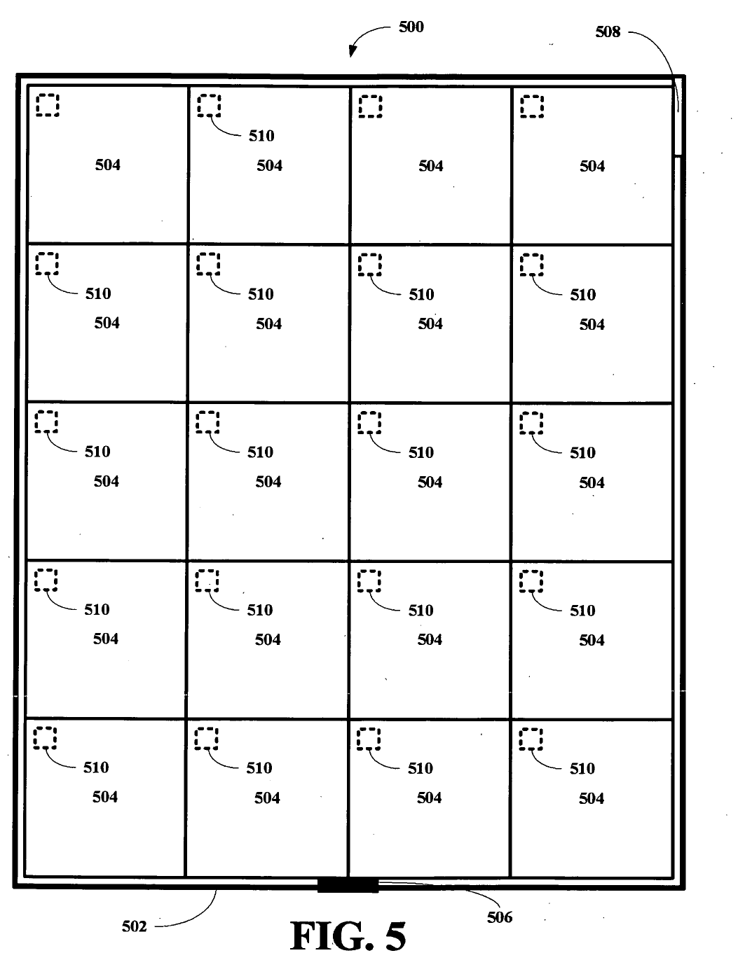

Referring now to FIG. 5, another embodiment of a waste management deployable kit or unit of this invention, generally 500, is shown to include a sealable container 502 including a plurality of sealable subcontainer 504 including an openable door (not shown) and an opening/closing/locking mechanism 506, where each subcontainer 504 can include a plurality of the same or different items described herein (not shown). The container 502 can include a tag 508, active or passive for tracking the items, and the tag 508 can include a GPS component for continuous, periodic or intermittent tracking of containers 502. The subcontainer 504 can include a tag 510, active or passive for tracking the items, and the tags 510 can include a GPS component for continuous, periodic or intermittent tracking of subcontainers 504. Of course, the exact dimensions of the container 502 and the number and makeup of the items will depend on the type of unit being prepared, how many people it is intended to handle.

### Implementation Flow Charts

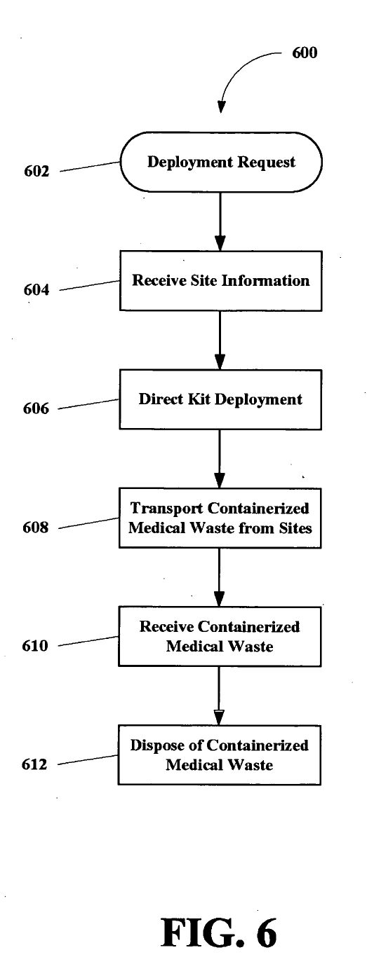

Referring now to FIG. 6, a conceptual flow chart of the operations of the system, generally 600, is shown to include the step of receiving a request for deployment 602 from a medical response agency. Once the request for deployment is received, the system 600 receives site information 604 from the agency including number of sites, site locations, estimated size of deployment—number of people to be treated, and type of emergency or non-emergency situation. The system 600 then distributes, from one or more warehousing facilities, sufficient waste management kits to each site to handle generated medical waste based on the deployment request in a distribution step 606. As the emergency or non-emergency situation unfolds and medical waste is accumulated, the response team forwards containerized medical waste to the indicated disposal facility in a transportation step 608. In certain embodiments, the transportation step 608 includes contacting a courier such as the United States Postage Service, UPS, DHL, FedEX or the like to pick up and deliver the containerized medical waste to the indicated disposal facility. In other embodiments, the transportation step 608 includes dispatching specialized hazardous waste handlers to collect and transport the containerized medical waste of the indicated disposal facility. The system 600 also includes the step of receiving the containerized medical waste at the indicated disposal facility, in a receiving containerized medical waste step 610. The system 600 also includes the step of disposing of the containerized medical waste, in a disposal step 612, where the medical waste is disposed of according to guidelines for handling the specific type of medical waste.

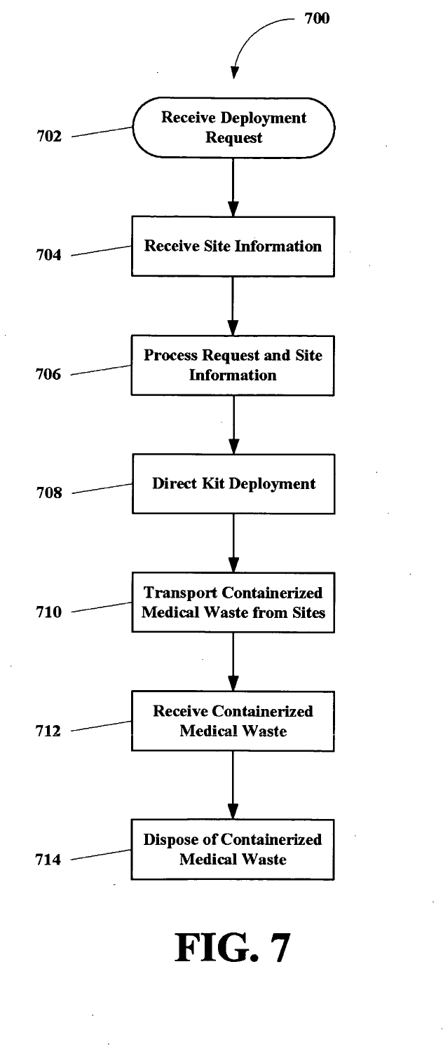

Referring now to FIG. 7, a conceptual flow chart of the operations of the system, generally 700, is shown to include the step of receiving a request for deployment 702 from a medical response agency. Once the request for deployment is received, the system 700 receives site information 704 from the agency including number of sites, site locations, estimated size of deployment—number of people to be treated, and type of emergency or non-emergency situation. The system 700 also includes the step of processing the deployment request and site information at a central command and control facility, in a processing step 706, where the command and control center determines which warehousing facilities are required to respond to the request. The central command and control center then directs one or more warehousing facilities to distribute kits to each site sufficient to collect generated medical waste based on the site information in a distribution step 708. As the emergency or non-emergency situation unfolds and medical waste is accumulated, the response team forwards containerized medical waste to the indicated disposal facility via a transportation step 710. In certain embodiments, the transportation step 712 includes contacting a courier such as the United States Postage Service, UPS, DHL, FedEX or the like to pick up and deliver the containerized medical waste to the indicated disposal facility. In other embodiments, the transportation step 712 includes dispatching specialized hazardous waste handlers to collect and transport the containerized medical waste of the indicated disposal facility. The system 700 also includes the step of receiving the containerized medical waste at the indicated disposal facility, in a receiving containerized medical waste step 712. The system 700 also includes the step of disposing of the containerized medical waste, in a disposal step 714, where the medical waste is disposed of according to guidelines for handling the specific type of medical waste.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A medical waste management system comprising:
a control subsystem including:
a plurality of local control units, each unit including command and control hardware,
software, routines, and protocols, and
communication hardware, software, routines, and protocols,
a distribution subsystem including:
at least: (1) a plurality of warehouse facilities having inventory control and management equipment, routines and protocols, each warehousing facility including at least: (a) a local command and control unit, (b) deployable waste management kits or units, and (c) sufficient inventory to prepare a desired number of deployable kits and to update deployable kits, and
(2) asset distribution equipment, routines and protocols
a tracking subsystem including:
hardware and software for tracking kits in the warehouse facilities and/or kits distributed to emergency or non-emergency sites
a retrieval subsystem including
retrieval equipment, routines and protocols, and
a disposal subsystem including:
disposal equipment, routines and protocols for disposing of any type of medical wastes.

2. The apparatus of claim 1, wherein the control subsystem further includes a command and control center for centralized management and control.

3. The apparatus of claim 1, wherein each warehousing facility further includes: (d) a kit preparation area, (e) an inventor storage area, (f) a kit storage area, and (g) a kit deployment or distribution area.

4. The apparatus of claim 1, wherein the tracking subsystem further includes active and/or passive tag technology to track kits and/or items in each of the kits.

5. The apparatus of claim 1, wherein the retrieval equipment, routines and protocols may be designed and authorized to handle various classifications of medical waste.

6. The apparatus of claim 1, wherein the disposal subsystem may also be designed and authorized to handle various classifications of medical waste.

7. A medical waste management system comprising:
a control subsystem including a central control unit and a plurality of local control units, each control unit includes command and control hardware, software, routines, and protocols and communication hardware, software, routines, and protocols;
a distribution subsystem including (1) a plurality of warehouse facilities having inventory control and management equipment, routines and protocols, and (2) asset distribution equipment, routines and protocols, each warehousing facility including: (a) a local command and control unit, (b) deployable waste management kits, and (c) sufficient inventory to prepare a desired number of deployable kits and to update deployable kits or units. Each warehousing facility can also include: (d) a kit preparation area, (e) an inventor storage area, (f) a kit storage area, and (g) a kit deployment or distribution area,
a tracking subsystem including hardware and software for tracking kits in the warehouse facilities and/or kits distributed to emergency or non-emergency sites and optionally active and/or passive tag technology to track kits and/or items in each of the kits;
a retrieval subsystem including retrieval equipment, routines and protocols and optionally retrieval equipment, routines and protocols designed and authorized to handle various classifications of medical waste; and
a disposal subsystem including disposal equipment, routines and protocols for disposing of any type of medical wastes and optionally disposal equipment, routines and protocols designed and authorized to handle various classifications of medical waste.

8. A method for implementing and using medical waste management system comprising the step of:
providing a control subsystem adapted to manage assets, warehouse assets, distribute asset, and collect and dispose of used assets, locally or collectively,
warehousing medical waste management system assets in one warehouse facility or a plurality of warehouse facilities including the steps of:
preparing deployable medical waste kits,
storing deployable medical waste kits, and
maintaining deployable medical waste kits;
in the event of a non-emergency or emergency situation or a plurality of non-emergency or emergency situations, distributing deployable medical waste kits via deployment transportation assets to one or more sites associated with the non-emergency or emergency local or non-emergency or emergency locals based on a deployment order or request, which specifies the number of kits needed, the location for delivery, and the type of kits needed, where the distributing step is adapted to distribute an effective number of warehoused deployable medical waste kits from one or more of the warehouse facilities to one site or a plurality of sites at each emergency or non-emergency local, where the number of deployable medical waste kits is sufficient to collect and temporarily store an amount of generated medical waste based the order or request and any subsequent orders;
retrieving the on-site medical waste via retrieval transportation assets and transporting the on-site medical waste to one or a plurality of disposal facilities;
disposing of the retrieved medical waste in one or more of the disposal facilities, where the disposal facilities are adapted to depose of all retrieved medical waste
tracking all deployed medical waste kits.

9. The method of claim 8, wherein the retrieval transportation assets include the United States Postal Service and/or non-governmental courier services.

10. The method of claim 8, wherein the retrieval transportation assets include appropriate hazardous waste material transportation assets.

11. The method of claim 8, wherein the medical wastes are sent to different disposal facilities depending on the type of medical waste involved.

12. The method of claim 8, wherein the tracking step include tracking all items within each deployable kit.

13. The method of claim 8, wherein the tracking step is performed by a local tracking subsystem associated with the local command and control unit.

14. The method of claim 8, wherein the tracking step is performed by a central tracking component associate with the central command and control subsystem and a plurality of facility or local tracking components associated with the local command and control units from which kits were deployed.

15. The method of claim 8, wherein the tracking subsystem includes the ability to track each deployed kit via global position technology.

16. The method of claim 8, wherein the tracking system includes the ability to track each deployed kit via global position technology and active or passive tags on each item in each kit so that the location of each item and each kit can be tracked for retrieval and disposal.

17. A method for implementing and using a medical waste management system comprising the step of:
providing a control subsystem including a central control unit and a plurality of local control units, where the central control unit is adapted to control the management of all assets, management of the warehousing of all medical waste management system (MWMS) assets, management of the distribution of all MWMS assets, management of the retrieval of all used MWMS assets, management of disposal of all retrieved MWMS assets, and optionally management of the tracking of all MWMS assets and where the local control units are adapted to manage local MWMS assets, manage warehousing of local MWMS assets, manage distribution of local MWMS assets, manage local retrieval of used MWMS assets, manage local disposal of retrieved MWMS assets and optionally manage local tracking MWMS assets;
warehousing medical waste management assets in one warehouse facility or a plurality of warehouse facilities including the steps of:
preparing deployable medical waste system kits,
storing deployable medical waste system kits, and
maintaining deployable medical waste system kits;
in the event of a non-emergency or emergency situation or a plurality of non-emergency or emergency situations, distributing deployable medical waste kits via deployment transportation assets to one or more sites associated with a non-emergency or emergency local or non-emergency or emergency locals based on a deployment order or request, where the distributing step is adapted to distribute an effective number of warehoused deployable medical waste kits from one or more of the warehouse facilities to one site or a plurality of sites at each emergency or non-emergency local, where the number of deployable medical waste kits is sufficient to collect and temporarily store an amount of generated medical waste based the order or request and any subsequent orders;
retrieving the collected and stored on-site medical waste via retrieval transportation assets and transporting the collected medical waste to one or more disposal facilities;
disposing of the retrieved medical waste in one or more of the disposal facilities, where the disposal facilities are adapted to depose of all retrieved medical waste
tracking all deployed medical waste kits,

18. The method of claim 17, wherein the retrieval transportation assets include the United States Postal Service and/or non-governmental courier services.

19. The method of claim 17, wherein the retrieval transportation assets include appropriate hazardous waste material transportation assets.

20. The method of claim 17, wherein the medical wastes are sent to different disposal facilities depending on the type of medical waste involved.

21. The method of claim 17, wherein the tracking step include tracking all items within each deployable kit.

22. The method of claim 17, wherein the tracking step is performed by a local tracking subsystem associated with the local command and control unit.

23. The method of claim 17, wherein the tracking step is performed by a central tracking component associate with the central command and control subsystem and a plurality of facility or local tracking components associated with the local command and control units from which kits were deployed.

24. The method of claim 17, wherein the tracking subsystem includes the ability to track each deployed kit via global position technology.

25. The method of claim 17, wherein the tracking system includes the ability to track each deployed kit via global position technology and active or passive tags on each item in each kit so that the location of each item and each kit can be tracked for retrieval and disposal.
